(19) United States
(12) Patent Application Publication
(10) Pub. No.: US 2025/0147139 A1
(43) Pub. Date: May 8, 2025

(54) OPTIMIZED ANGLE OF ARRIVAL (AoA) DETERMINATION

(71) Applicant: HELLA GmbH & Co. KGaA, Lippstadt (DE)

(72) Inventors: Roman CURKIN, Lippstadt (DE); Ludger WEGHAUS, Lippstadt (DE)

(73) Assignee: HELLA GmbH & Co. KGaA, Lippstadt (DE)

(21) Appl. No.: 18/939,588

(22) Filed: Nov. 7, 2024

(30) Foreign Application Priority Data
Nov. 7, 2023 (DE) 10 2023 130 758.4
Mar. 15, 2024 (EP) 24 163 800.6

(51) Int. Cl. G01S 3/46

(52) U.S. Cl. CPC G01S 3/46

(57) ABSTRACT

A method for determining an angle of arrival and/or a direction of arrival of an electromagnetic wave from a mobile device to a receiving unit, in particular a UWB receiver. The receiving unit includes at least two receiving antennas, For determining the angle of arrival and/or the direction of arrival, a phase difference of arrival between signal responses at the receiving antennas is ascertained. The phase difference of arrival is ascertained at such a location in the signal responses that is still situated in the signal responses prior to a particular midpoint of a first signal path.

This nonprovisional application claims priority under 35 U.S.C. § 119 (a) to German Patent Application No. 10 2023 130 758.4, which was filed in Germany on Nov. 7, 2023, and to European Patent Application No. 24 163 800.6, which was filed in Europe on Mar. 15, 2024, which are both herein incorporated by reference.

### BACKGROUND OF THE INVENTION

### Field of the Invention

The invention relates to a method for determining an angle of arrival (or AoA for short) and/or a direction of arrival (or DoA for short) of an electromagnetic wave from a mobile device to a receiving unit, in particular a UWB receiver. The invention further relates to a corresponding computer program product, a corresponding control unit, and a corresponding receiving unit, in particular a corresponding UWB receiver, for carrying out such a method.

### Description of the Background Art

Methods for determining an angle of arrival or a direction from which an electromagnetic radio wave enters a receiver are basically known. For this purpose, a receiver may be designed with two receiving antennas, for example. The angle of arrival may be calculated from a phase difference of arrival (or PDoA for short) at the two receiving antennas. Problems arise in particular when the receiver is installed near metal, which is the case for the receivers that are used, for example, for access systems in vehicles that are installed near the vehicle body. The proximity of the metal results in signal paths that are only marginally longer than the first signal path or the direct line of sight (or LoS for short) of the receiver, i.e., the shortest signal path. Such signal paths may influence the ascertainment of the phase difference of arrival for the shortest signal path (i.e., the signal path of interest or of importance), resulting in incorrect results for the phase difference of arrival and thus adversely affecting the determination of the angle of arrival or the direction of arrival.

For example, a scenario as follows may be described. A mobile device, for example a smart phone, is intended to be localized with respect to the vehicle, using a receiver, for example via UWB. It is possible that only a single receiver receives signals from the mobile device. This may occur when other receivers are covered and/or when the signal is weak. In such a case, this receiver can measure the distance from the mobile device. When at least two antennas are situated in this receiver at a defined distance from one another (less than X2), the phase difference of arrival of the signals at the two antennas can be ascertained. The angle of arrival of the signals may thus be determined from the phase difference of arrival. This function may be advantageous for access systems in vehicles.

The midpoint of the first signal path of the signals is usually used for ascertaining the phase difference of arrival. As explained above, such an ascertainment of the phase difference of arrival at the midpoint of the first signal path of the signals may result in incorrect results in the determination of the angle of arrival or the direction of arrival. The reason is that the UWB pulses do not represent an ideal Dirac pulse (t=0), but instead have a limited pulse width of approximately 2 ns, for example. Signal components in the channel impulse response (CIR) that extend over several nanoseconds thus become visible. When a UWB receiver is installed near metal, this may result in strong reflection paths, depending on the radiation direction, which are only a few centimeters longer than the first signal path of interest, and whose signal components overlap and thus distort the signal component of the first signal path. Therefore, in this context it is not optimal to determine the phase difference of arrival at the midpoint of the first signal path.

### SUMMARY OF THE INVENTION

It is therefore an object of the present invention to at least partially overcome at least one of the disadvantages described above. The object of the invention in particular is to provide a method for determining an angle of arrival and/or a direction of arrival of an electromagnetic wave from a mobile device to a receiving unit, in particular a UWB receiver, which allows an improved determination of the angle of arrival and/or the direction of arrival which has enhanced accuracy, allows improved access functions for vehicles, increases customer convenience, and increases confidence in the access systems. A further object of the present invention is to provide a corresponding computer program product, a corresponding receiving unit, in particular a corresponding UWB receiver, for carrying out such a method.

The present invention provides a method for determining an angle of arrival and/or a direction of arrival of an electromagnetic wave from a mobile device to a receiving unit, in particular a UWB receiver, having the features of the independent method claim. Furthermore, the invention provides a corresponding computer program product, a corresponding control unit, and a corresponding receiving unit, in particular a corresponding UWB receiver, having the features of the other independent claims. Features and details described in conjunction with the different embodiments and/or aspects of the invention of course also apply in conjunction with the other embodiments and/or aspects, and vice versa, so that mutual reference is or may always be made to the disclosure concerning the individual embodiments and/or aspects.

The present invention provides a method for determining an angle of arrival and/or a direction of arrival of an electromagnetic wave from a mobile device to a receiving unit, in particular a UWB receiver. The receiving unit includes at least two receiving antennas. For determining the angle of arrival and/or the direction of arrival, a phase difference of arrival between signal responses at the receiving antennas is ascertained. For this purpose, it is proposed that the phase difference of arrival is ascertained at such a location/locations in the signal responses that is/are still situated in the signal responses prior to a particular midpoint (M) of a first signal path (of first signal paths).

The signal response may likewise be referred to as a channel impulse response (CIR).

The first signal path or the direct line of sight (LoS) of the receiver may thus be referred to as the shortest signal path.

The invention recognizes that ascertaining the phase difference of arrival at the midpoint of the first signal path of the signals is not optimal, since reflection paths may form due to metallic parts on the vehicle which may distort the signal component of the first signal path.

The invention proposes that the phase difference of arrival in the signal response is calculated not at the midpoint of the first signal path, but, rather, at an earlier (preferably earliest possible) location, in which the signal response exceeds, for example, a certain or specifically set threshold value.

The influence of signal components of the somewhat longer reflection paths, which may overlap and thereby distort the signal component of the first signal path, is thus reduced when ascertaining the phase difference of arrival.

Moreover, it may be provided that the phase difference of arrival is ascertained at the location (or at such locations) of signal responses which in the signal responses exceed(s) a certain, preferably specifically selected or calculated, threshold value. It may thus be possible for the phase difference of arrival to be ascertained at an earlier (earliest possible) location, namely, when the signal response has exceeded the threshold value.

Furthermore, it may be provided that the threshold value is determined in such a way that the location(s) at which the phase difference of arrival is ascertained occur(s) as early as possible in the signal responses and is/are already above a noise level (or noise levels). It may thus be possible for the phase difference of arrival to be ascertained as soon as possible, namely, when the signal response can be distinguished from the noise level.

On the one hand, it is possible for the threshold value to be determinable as a function of an absolute value of a signal response. On the other hand, it is possible for the threshold value to be determinable as a function of an absolute value of a real part and/or as a function of an absolute value of an imaginary part of a signal response. The threshold value may be determined, for example, in such a way that in the signal response (for example, the absolute value of the signal response, which has a real part and an imaginary part and may be regarded as a complex number), a plurality of values caused by noise are awaited for at least 2 to 5 ns temporally prior to the recognized midpoint of the first signal path. The threshold value may be selected, for example, so that it is above the noise level. Thus, a location or a point of the signal response may be considered in which the signal curve is still ascending toward the midpoint of the first signal path. The absolute value of the signal response and/or the absolute value of the real part and/or the absolute value of the imaginary part of the signal response may be regarded as signals.

In addition, it is possible, when the threshold value is determined as a function of an absolute value of a real part and as a function of an absolute value of an imaginary part of a signal response, for the respective earlier point in time to be selected as a relevant location for ascertaining the phase difference of arrival. In other words, in each case the respective earlier point in time may be selected as relevant for the ascertainment.

Moreover, it may be provided that the threshold value is determined as a function of two threshold values. For example, it is possible for the threshold value to be determinable as a maximum value of two threshold values. In addition, a first threshold value may be determined as a function of a noise level, and a first factor, in particular greater than one. Furthermore, a second threshold value may be determined as a function of the first signal path in the signal responses and a second factor, in particular less than one. In other words, the threshold value may be defined as a combination of two differently calculated threshold values, for example as a maximum value or the larger of the two threshold values.

The first threshold value may be a threshold value which ensures that the signal response is from the noise, and first signal components of the first signal path become active. A first factor may be defined which, for example, is much larger than 1, for example 5, by which the noise level is multiplied. For example, a maximum value of numerous absolute values in the noise range may be selected in order to determine the noise level. The first threshold value may then be determined as follows:

$$S 1 = F 1 ⋆ max ( abs ( CIR\_Noise ) ) .$$

The second threshold value may be a threshold value that may represent a fraction of the average value or of the pick of the first signal path of the signal curve. A second factor less than 1, for example 0.2, may be defined, so that the second threshold value may be determined as follows:

$$S 2 = F 2 * abs ( CIR\_Pick ) .$$

To ensure that the final threshold value is sufficiently above the noise level and also comes as early as possible before the average value or pick of the first signal path of the signal curve, the final threshold value may be determined from the combination of two threshold values.

The signal responses at the two receiving antennas may be advantageously synchronized, in particular by use of the respective earlier points in time, as a relevant location for ascertaining the phase difference of arrival. When the sampling by the receiving antennas does not occur exactly synchronously, the signal responses may preferably be synchronized based on the earlier point in time, as a result of which, for example, a slight displacement along the x axis may take place so that the respective earlier points in time are precisely superposed for both receiving antennas.

During a determination of a phase position for a first receiving antenna and a phase position for a second receiving antenna, a possible phase offset, which may be based on the antenna design, for example, may preferably be taken into account. In other words, during the determination of the phase position for the first receiving antenna and the second receiving antenna, a possible phase offset, which may be based on the antenna design, for example, may be taken into account.

In addition, it is possible, when the receiving antennas recognize and/or output a different first signal path in the signal responses, for the earlier first signal path to preferably then be used for determining the threshold value. Furthermore, it is possible, when the receiving antennas recognize and/or output a different first signal path in the signal responses, for the first signal path of a predefined receiving antenna to then be used for determining the threshold value. A reliable determination may thus be made possible, despite any signal differences.

Moreover, it may be provided that the signal responses are interpolated to form a continuous curve by use of a filter, in particular using a fraction, for example one-tenth, of a sampling increment of signal responses, preferably by use of a filter having the property that the location(s) in the signal responses for ascertaining the phase difference of arrival remain(s) unchanged. Since the signal responses are usually sampled at fixed sampling points in time, for example at 1 GHZ, and thus in the time increments, for example every 1 ns, they result in raw values in the particular signal response, it may be advantageous to interpolate these raw values to form a smooth curve, for example using one-tenth (or a similar value) of the actual sampling increment, by use of a filter. A filter having the property that the supporting points in the interpolated signal remain unchanged may preferably be used.

In addition, it may be provided that a location history of the mobile device is taken into account when determining the angle of arrival and/or the direction of arrival. Improved results may be achieved in this way.

Furthermore, it may be provided that when determining the angle of arrival and/or the direction of arrival, the phase difference of arrival is ascertained multiple times over a time window, and a result is determined based on the ascertained values, for example as an average value. A reliable ascertainment may thus be made possible.

A signal strength at the first signal path and/or at the location (or the locations) in the signal responses that is/are used for ascertaining the phase difference of arrival may advantageously be taken into account in order to refine the determination of the angle of arrival and/or the direction of arrival. It may preferably be taken into account that the signal strength of the signal response for the receiving antenna is greater the closer it is to the mobile device.

Moreover, it may be provided that for determining the angle of arrival and/or the direction of arrival, selected results, which are preferably selected using a machine learning method and/or which originate in particular from different receiving units, are taken into account in ascertaining the phase difference of arrival. Additional information that is output, such as signal strengths, may advantageously be examined via machine learning methods, for example in conjunction with the information that is calculated for the phase difference of arrival, in order to determine the best possible results from the data material that is present. Training may take place during the development and also in the field. In the field, for example when the vehicle has been purchased and is on the street, the angle of arrival and/or the direction of arrival may then be determined by multilateration, at least whenever this is possible. Furthermore, only data material having high reliability is used.

Moreover, it may be provided that during determination of the angle of arrival and/or the direction of arrival, a confidence level (or C for short) is output which may be a function, for example, of a signal strength and/or of the determined angle of arrival and/or of the determined direction of arrival. Results from different receiving units may preferably be taken into account for determining the angle of arrival and/or the direction of arrival. For determining the angle of arrival and/or the direction of arrival, results from such a receiving unit which have a high, advantageously the highest, confidence level may preferably be taken into account. The best value may preferably be selected by use of a machine learning method. In addition to the phase difference of arrival (or the resulting angle of arrival and/or the direction of arrival), an associated descriptive confidence level may be calculated and output. The confidence level, i.e., the information concerning the reliability of the results of ascertaining the phase difference of arrival or of determining the angle of arrival, is highest for perpendicularly incident wave fronts (AoA=) 0°, and drops toward the boundary regions, i.e., when the wave fronts arrive from the side (AoA=approximately −90° or) 90°. The calculation of this value may preferably also be enhanced by additional measurements at the vehicle, for example when it is known that certain angle positions give less accurate results. A calibration using the confidence level may take place in the field, preferably in a self-learning manner, for example whenever multiple UWB receivers are simultaneously accessed, or when multiple UWB receivers can measure distances from the mobile device. It is then possible to determine the actual location of the mobile device relative to the vehicle via multilateration.

In addition, the positions of the UWB receivers at the vehicle may advantageously be taken into account in order to improve the results of ascertaining the phase difference of arrival or determining the angle of arrival.

The present invention provides a computer program product that includes commands which, when the computer program product is executed by a computer, prompt the computer to carry out a method that is able to run as described above. By use of the computer program product, the same advantages may be achieved as described above in conjunction with the method according to the invention. In the present case, reference is made in full to these advantages.

The present invention provides a control unit (ECU) that includes a processing unit, and a memory unit in which a code is stored which, when at least partially executed by the processing unit, carries out a method that may run as described above. By use of the control unit (ECU), the same advantages may be achieved as described above in conjunction with the method according to the invention. In the present case, reference is made in full to these advantages.

The present invention provides a receiving unit (100), in particular a UWB receiver, for a vehicle which includes a control unit (ECU) that may be designed as described above. By use of the receiving unit (100), the same advantages may be achieved as described above in conjunction with the method according to the invention. In the present case, reference is made in full to these advantages.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example explanation for carrying out a method according to an example, and

FIG. 2 shows an example illustration of the locations in the signal responses at which improved results may be achieved.

### DETAILED DESCRIPTION

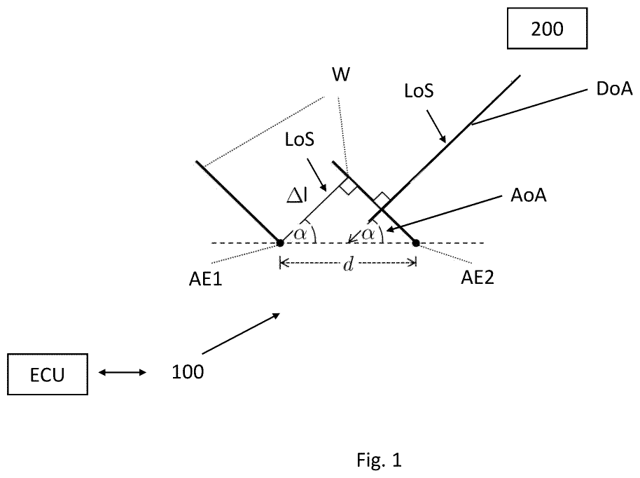

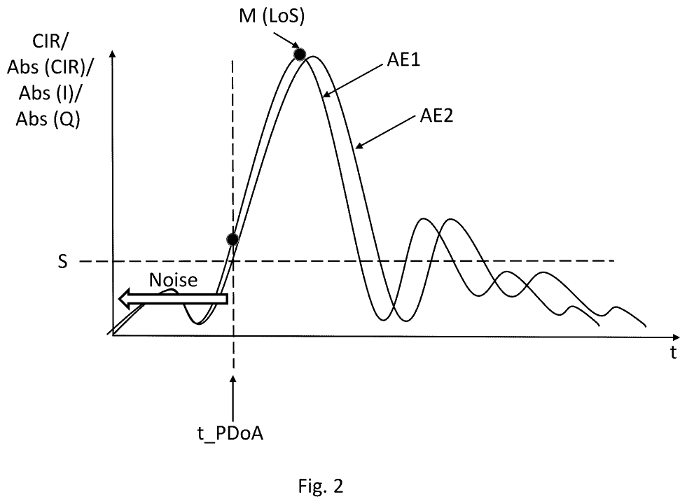

The invention proposes a method for determining an angle of arrival (AoA) and/or a direction of arrival (DoA) of an electromagnetic wave W from a mobile device 200 to a receiving unit 100, in particular a UWB receiver, which is explained with reference to FIGS. 1 and 2.

At least two receiving antennas AE1 and AE2 may be provided for the receiving unit 100 or for the UWB receiver.

The angle of arrival AoA, which in FIG. 1 is also denoted by reference symbol a, may be calculated from a phase difference of arrival (PDoA) at the two receiving antennas AE1, AE2.

The invention recognizes that when the receiving unit 100 or the UWB receiver is installed near metal, for example near a vehicle body, problems may arise in ascertaining the phase difference of arrival PDoA or the angle of arrival AoA or the direction of arrival DoA.

The proximity of the metal may result in signal paths that are only marginally longer than the first signal path (line of sight (LOS)), i.e., the direct line of sight of the receiving unit 100 or the UWB receiver, i.e., the shortest signal path. Such signal paths may influence the ascertainment of the phase difference of arrival PDoA for the shortest signal path or the first signal path LoS (i.e., the signal path of interest or of importance), which results in incorrect results in ascertaining the phase difference of arrival PDoA and thus adversely affects the determination of the angle of arrival AoA or the direction of arrival DoA.

An application example as follows is possible. A mobile device 200, for example a phone, is to be localized with regard to the vehicle by use of the receiving unit 100 or the UWB receiver. It is possible that only a single UWB receiver receives signals from the mobile device 200. This may occur, for example, when other UWB receivers are covered and/or when the signal from the mobile device 200 is weak. In such a case, the UWB receiver can measure the distance from the mobile device 200. When at least two receiving antennas AE1, AE2 are situated in this receiver at a defined distance d from one another (d=less than X2), the phase difference of arrival PDoA of the signals at the two antennas AE1, AE2 can be ascertained. The angle of arrival AoA or the direction of arrival DoA of the signals may thus be determined from the phase difference of arrival PDoA. This function may be advantageous for access systems in vehicles.

The phase difference of arrival PDoA may also be referred to as the phase difference ΔΦ, and the angle of arrival AoA, as the angle α.

The wave front W under consideration arrives at the second receiving antenna AE2 at point in time t0, and arrives at the first receiving antenna AE1 at point in time (t0+Δl/c0), with a path difference Δl as illustrated in FIG. 1. Thus, with the period duration T or the frequency f, the following is obtained:

$$ΔΦ = 2 π f ( Δ l / {c}_{0} ) .$$

The relationship with the angle of arrival AoA is as follows:

$$Δ Φ = ( 2 π / λ ) d cos α .$$

When the phase difference ΔΦ or the phase difference of arrival PDoA is known, the angle of arrival AoA may be calculated as follows:

$$α = arccos ( ( ΔΦλ ) / ( 2 π d ) ) .$$

In the known method, the midpoint M or the peak in the first signal path LoS of the signals is used for ascertaining the phase difference of arrival PDoA. As explained above, such an ascertainment of the phase difference of arrival at the first signal path of the signals may result in incorrect results in determining the angle of arrival AoA or the direction of arrival DoA.

The invention recognizes that the UWB pulses do not represent an ideal Dirac pulse (t=0), but instead have a limited pulse width of approximately 2 ns, for example. Signal components in the channel impulse response (CIR) that extend over a few nanoseconds thus become visible. When a UWB receiver is installed near metal, this results in strong reflection paths, depending on the radiation direction, which are only a few centimeters longer than the first signal path LoS of interest, and whose signal components overlap and thus distort the signal component of the first signal path. Therefore, in this context it is not optimal to determine the phase difference of arrival only at the midpoint M or peak of the first signal path LoS.

The proposed method allows improved determination of the angle of arrival AoA and/or the direction of arrival DoA which has enhanced accuracy, allows improved access functions for vehicles, increases customer convenience, and increases confidence in the access systems.

As indicated in FIG. 2, according to the invention it is proposed that the phase difference of arrival PDoA is ascertained at such a location (or at such locations) in the signal responses CIR that is/are still situated in the signal responses CIR prior to (in the temporal sense) a particular midpoint M of a first signal path LoS.

In other words, the invention proposes that the phase difference of arrival PDoA in the signal response CIR is calculated not at the midpoint M of the first signal path LoS, but, rather, at an earlier (preferably earliest possible) location in which the signal response CIR exceeds, for example, a certain or specifically set threshold value S.

The influence of signal components of the somewhat longer reflection paths, which may overlap and thereby distort the signal component of the first signal path LoS, may thus be reduced when ascertaining the phase difference PDoA.

As indicated in FIG. 2, the threshold value S may be determined in such a way that the location or the locations at which the phase difference of arrival PDoA is ascertained occur(s) as early as possible in the signal responses CIR, and is/are already above a noise level Noise.

As indicated strictly schematically in FIG. 2, it is possible for the threshold value S to be determinable as a function of an absolute value Abs CIR of a signal response CIR. On the other hand, it is possible for the threshold value S to be determinable as a function of an absolute value Abs I of a real part I and/or as a function of an absolute value Abs Q of an imaginary part Q of a signal response CIR.

The threshold value S may be determined, for example, in such a way that in the signal response CIR (for example, the absolute value Abs CIR of the signal response CIR, which has a real part I and an imaginary part Q and may be regarded as a complex number), a plurality of values caused by noise Noise are awaited for at least 2 to 5 ns temporally prior to the recognized midpoint M of the first signal path LoS.

The threshold value S may be selected, for example, so that it is above the noise level Noise. Thus, a location or a point of the signal response CIR may be considered in which the signal curve is still ascending toward the midpoint M of the first signal path CIR.

The absolute value Abs CIR of the signal response CIR and/or the absolute value Abs I of the real part I and/or the absolute value Abs Q of the imaginary part Q of the signal response CIR may be regarded as signals (see FIG. 2).

Moreover, it is possible for the threshold value to be determined as a function of two threshold values S1, S2. For example, it is possible for the threshold value S to be determinable as a maximum value (S1, S2) of two threshold values S1, S2.

For example, a first threshold value S1 may be determined as a function of a noise level Noise and a first factor F1, in particular greater than one.

For example, a second threshold value S2 may be determined as a function of the first signal path LOS in the signal responses CIR and a second factor F2, in particular less than one.

The first threshold value S1 may be a threshold value which ensures that the signal response CIR is from the noise, and first signal components of the first signal path become active. A first factor F1 may be defined which, for example, is much larger than 1, for example 5, by which the noise level Noise is multiplied. For example, a maximum value of numerous absolute values Abs CIR in the noise range may be selected in order to determine the noise level Noise. The first threshold value S1 may then be determined as follows:

$$S 1 = F 1 ⋆ max ( abs ( CIR\_Noise ) ) .$$

The second threshold value S2 may be a threshold value that may represent a fraction of the average value M or of the pick Abs (CIR_Pick) of the first signal path of the signal curve. A second factor F2 less than 1, for example 0.2, may be defined, so that the second threshold value S2 may be determined as follows:

$$S 2 = F 2 * abs ( CIR\_Pick ) .$$

To ensure that the final threshold value S is sufficiently above the noise level Noise and also comes as early as possible before the average value M or Pick abs (CIR_Pick) of the first signal path of the signal curve, the final threshold value S may be determined from the combination of two threshold values S1, S2.

During the determination of the phase position for a first receiving antenna AE1 and the second receiving antenna AE2, a possible phase offset, which may be based on the antenna design, for example, may be taken into account.

In addition, it is possible, when the receiving antennas AE1, AE2 recognize and/or output a different first signal path LoS in the signal responses CIR, for the earlier first signal path LoS to preferably then be used for determining the threshold value S. A reliable determination may thus be made possible, despite any signal differences

Since the signal responses CIR are usually sampled at fixed sampling points in time, for example at 1 GHZ, and in the time increments, for example every 1 ns, they result in raw values in the particular signal response CIR, it may be advantageous to interpolate these raw values to form a smooth curve, for example using one-tenth (or a similar value) of the actual sampling increment, by use of a filter. A filter having the property that the supporting points in the interpolated signal remain unchanged may preferably be used.

A location history of the mobile device 200 may be advantageously taken into account during determination of the angle of arrival AoA and/or the direction of arrival DoA.

Furthermore, during the determination of the angle of arrival AoA and/or the direction of arrival DoA, the phase difference of arrival PDoA may be ascertained multiple times over a time window, and a result may be determined based on the ascertained values, for example as an average value.

A signal strength at the first signal path LOS and/or at the location (or locations) in the signal responses CIR that are/is used for ascertaining the phase difference of arrival PDoA may advantageously be taken into account in order to refine the determination of the angle of arrival AoA and/or the direction of arrival DoA. It may preferably be taken into account that the signal strength of the signal response CIR for the receiving antenna AE1, AE2 is greater the closer it is to the mobile device 200.

In addition, for determining the angle of arrival AoA and/or the direction of arrival DoA, selected results, which are preferably selected using a machine learning method and/or which originate in particular from different receiving units 100, may be taken into account in ascertaining the phase difference of arrival PDoA. Additional information that is output, such as signal strengths, may advantageously be examined via machine learning methods, for example in conjunction with the information that is calculated for the phase difference of arrival PDoA, in order to determine the best possible results from the data material that is present. Training may take place during the development and also in the field. In the field, for example when the vehicle has been purchased and is on the street, the angle of arrival AoA and/or the direction of arrival DoA may then be determined by multilateration, at least whenever this is possible. Furthermore, only data material having high reliability is used.

Moreover, during determination of the angle of arrival AoA and/or the direction of arrival DoA, a confidence level (C) may be output which may be a function, for example, of a signal strength and/or of the determined angle of arrival AoA and/or of the determined direction of arrival DoA.

Different receiving units 100 may preferably be taken into account for determining the angle of arrival AoA and/or the direction of arrival DoA.

Results from such a receiving unit 100 which have a high, advantageously the highest, confidence level C may preferably be taken into account for determining the angle of arrival AoA and/or the direction of arrival DoA.

The best value may preferably be selected by use of a machine learning method.

The confidence level C, i.e., the information concerning the reliability of the results of ascertaining the phase difference of arrival PDoA or of determining the angle of arrival AoA, is highest for perpendicularly incident wave fronts (AoA=) 0°, and drops toward the boundary regions, i.e., when the wave fronts arrive from the side (AoA=approximately −90° or) 90°.

The calculation of this value may preferably also be enhanced by additional measurements at the vehicle, for example when it is known that certain angle positions give less accurate PDoA or AoA results.

A calibration by use of the confidence level C may take place in the field, preferably in a self-learning manner, for example whenever multiple UWB receivers are simultaneously accessed, or when multiple UWB receivers can measure distances from the mobile device. It is then possible to determine the actual location of the mobile device 200 relative to the vehicle via multilateration.

In addition, the positions of the UWB receivers at the vehicle may advantageously be taken into account in order to improve the results of ascertaining the phase difference of arrival PDoA or determining the angle of arrival AoA.

The invention further relates to a corresponding computer program product, a corresponding control unit, and a corresponding receiving unit 100, in particular a corresponding UWB receiver, for carrying out such a method

In the above explanation of the embodiments, the present invention is described solely in terms of examples. Of course, individual features of the embodiments, if technically feasible, may be freely combined with one another without departing from the scope of the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining an angle of arrival and/or a direction of arrival of an electromagnetic wave from a mobile device to a receiving unit, the method comprising:
providing the receiving unit with at least two receiving antennas;
determining the angle of arrival and/or the direction of arrival by ascertaining a phase difference of arrival between signal responses at the at least two receiving antennas; and
ascertaining the phase difference of arrival at such a location in the signal responses that is still situated in the signal responses prior to a particular midpoint of a first signal path.

2. The method according to claim 1, wherein the phase difference of arrival is ascertained at the location of signal responses that exceed a certain threshold value in the signal responses.

3. The method according to claim 2, wherein the threshold value is determined such that the location at which the phase difference of arrival is ascertained occurs as early as possible in the signal responses and prior to the midpoint and is already above a noise level.

4. The method according to claim 2, wherein the threshold value is determined as a function of an absolute value of a signal response, and/or wherein the threshold value is determined as a function of an absolute value of a real part and/or as a function of an absolute value of an imaginary part of a signal response.

5. The method according to claim 2, wherein, when the threshold value is determined as a function of an absolute value of a real part and as a function of an absolute value of an imaginary part of a signal response, the respective earlier point in time is selected as a relevant location for ascertaining the phase difference of arrival.

6. The method according to claim 2, wherein the threshold value is determined as a function of two threshold values, and/or wherein the threshold value is determined as a maximum value of two threshold values, and/or wherein a first threshold value is determined as a function of a noise level and a first factor that is greater than one, and/or wherein a second threshold value is determined as a function of the first signal path in the signal responses and a second factor that is less than one.

7. The method according to claim 1, wherein during a determination of a phase position for a first receiving antenna and a phase position for a second receiving antenna, a possible phase offset, which is based on the antenna design is taken into account.

8. The method according to claim 1, wherein, when the receiving antennas recognize and/or output a different first signal path in the signal responses, the earlier first signal path is then used for determining the threshold value or the first signal path of a predefined receiving antenna is used.

9. The method according to claim 1, wherein the signal responses are interpolated to form a continuous curve by use of a filter using a fraction, in particular one-tenth, of a sampling increment of signal responses, via a filter having a property that the location in the signal responses for ascertaining the phase difference of arrival remains unchanged, and/or a location history of the mobile device is taken into account when determining the angle of arrival and/or the direction of arrival, and/or the phase difference of arrival is ascertained multiple times over a time window, and a result is determined based on the ascertained values, for example as an average value.

10. The method according to claim 1, wherein a signal strength at the first signal path and/or at the location in the signal responses that is used for ascertaining the phase difference of arrival is taken into account in order to refine the determination of the angle of arrival and/or the direction of arrival, and/or it is taken into account that the signal strength of the signal response for the receiving antenna is greater the closer it is to the mobile device.

11. The method according to claim 1, wherein, for determining the angle of arrival and/or the direction of arrival, selected results, which are selected using a machine learning method and/or which originate from different receiving units are taken into account in ascertaining the phase difference of arrival.

12. The method according to claim 1, wherein during determination of the angle of arrival and/or the direction of arrival, a confidence level is output, which is a function of a signal strength and/or of the determined angle of arrival and/or of the determined direction of arrival, and/or wherein results from different receiving units are taken into account for determining the angle of arrival and/or the direction of arrival, and/or wherein results from such a receiving unit, which have a high confidence level that is selected using a machine learning method, are taken into account for determining the angle of arrival and/or the direction of arrival, and/or wherein positions of the receiving units at the vehicle are taken into account in determining the angle of arrival and/or the direction of arrival.

13. A computer program product that comprises commands which, when the computer program product is executed by a computer, prompt the computer to carry out the method according to claim 1.

14. A control unit comprising:
a processing unit; and
a memory unit in which a code is stored, which, when at least partially executed by the processing unit, carries out the method according to claim 1.

15. A receiving unit, in particular a UWB receiver, for a vehicle that comprises the control unit according to claim 14.

16. The method according to claim 1, wherein the receiving unit is a UWB receiver.
